(19) United States
(12) Patent Application Publication
(10) Pub. No.: US 2026/0203556 A1
(43) Pub. Date: Jul. 16, 2026

(54) AUTONOMOUS DECISION-MAKING BY ESTIMATING PERFORMANCE OF ARTIFICIAL INTELLIGENCE AGENTS

(71) Applicant: NEC Laboratories America, Inc., Princeton, NJ (US)

(72) Inventor: Christopher Malon, Fort Lee, NJ (US)

(21) Appl. No.: 19/439,936

(22) Filed: Jan. 5, 2026

Related U.S. Application Data
(60) Provisional application No. 63/744,400, filed on Jan. 13, 2025.

(51) Int. Cl. G06N 3/0455; G06N 3/042

(52) U.S. Cl. CPC G06N 3/0455; G06N 3/042

(57) ABSTRACT

Systems and methods for autonomous decision-making by estimating performance of artificial intelligence agents. An auditing performance of artificial intelligence (AI) agents to an input query can be tested. A query embedding from the input query and a skill embedding can be extracted with a transformer model from the auditing performance of the AI agents of skill features utilized for solving the input query. An expected performance of the AI agents on the input query can be determined based on the query embedding and the skill embedding. A downstream task can be performed with an AI agent selected from the AI agents based on the expected performance through autonomous decision making to resolve determined issues based on the input query.

### RELATED APPLICATION INFORMATION

This application claims priority to U.S. Provisional App. No. 63/744,400, filed on January 13, 2025, incorporated herein by reference in its entirety.

### BACKGROUND

### Technical Field

The present invention relates to optimizing artificial intelligence (AI) models, and more particularly to autonomous decision-making by estimating performance of artificial intelligence agents.

### Description of the Related Art

AI models have been widely adopted in various fields and has been present in most computer system today. For example, AI models have been used for image processing and video processing. However, AI models can be specialized for the domain that they are trained on which can result in inaccurate predictions for other domains.

### SUMMARY

According to an aspect of the present invention, a method is provided including, testing an auditing performance of artificial intelligence (AI) agents to an input query, extracting, with a transformer model, a query embedding from the input query and a skill embedding from the auditing performance of the AI agents of skill features utilized for solving the input query, determining an expected performance of the AI agents on the input query based on the query embedding and the skill embedding, and performing a downstream task with an AI agent selected from the AI agents based on the expected performance through autonomous decision making to resolve determined issues based on the input query.

According to another aspect of the present invention, a system is provided including a memory device, one or more processor devices operatively coupled with the memory device to perform operations including, testing an auditing performance of artificial intelligence (AI) agents to an input query, extracting, with a transformer model, a query embedding from the input query and a skill embedding from the auditing performance of the AI agents of skill features utilized for solving the input query, determining an expected performance of the AI agents on the input query based on the query embedding and the skill embedding, and performing a downstream task with an AI agent selected from the AI agents based on the expected performance through autonomous decision making to resolve determined issues based on the input query.

According to yet another aspect of the present invention, a non-transitory computer program product is provided including a computer-readable storage medium including a program code, wherein the program code when executed on a computer causes the computer to perform operations including, testing an auditing performance of artificial intelligence (AI) agents to an input query, extracting, with a transformer model, a query embedding from the input query and a skill embedding from the auditing performance of the AI agents of skill features utilized for solving the input query, determining an expected performance of the AI agents on the input query based on the query embedding and the skill embedding, and performing a downstream task with an AI agent selected from the AI agents based on the expected performance through autonomous decision making to resolve determined issues based on the input query.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for automated decision making by estimating performance of artificial intelligence agents, in accordance with an embodiment of the present invention;

FIG. 2 is a block diagram that shows a computer system for automated decision making by estimating performance of artificial intelligence agents, in accordance with an embodiment of the present invention;

FIG. 3 is a block diagram that shows components of a computer system for automated decision making by estimating performance of artificial intelligence agents, in accordance with an embodiment of the present invention;

FIG. 4 is a block diagram that shows a neural network for optimized multi-modality processing with artificial intelligence agents, in accordance with an embodiment of the present invention;

FIG. 5 is a block diagram that shows a high-level overview of a method for autonomous decision-making by estimating performance of artificial intelligence agents, in accordance with an embodiment of the present invention; and

FIG. 6 is a block diagram that shows practical applications of autonomous decision-making by estimating performance of artificial intelligence agents, in accordance with an embodiment of the present invention.

### DETAILED DESCRIPTION OF PREFERRED EMBODIMENTS

In accordance with embodiments of the present invention, systems and methods are provided for autonomous decision-making by estimating performance of artificial intelligence agents.

In the present embodiments, an auditing performance of artificial intelligence (AI) agents to an input query can be tested. A query embedding from the input query and a skill embedding can be extracted with a transformer model from the auditing performance of the AI agents of skill features utilized for solving the input query. An expected performance of the AI agents on the input query can be determined based on the query embedding and the skill embedding. A downstream task can be performed with an AI agent selected from the AI agents based on the expected performance through autonomous decision making to resolve determined issues based on the input query.

Due to the rapid progress of artificial intelligence adoption, it is inevitable that an ecosystem of autonomous specialized artificial intelligence (AI) models (e.g., LLMs) for decision support would exist. The specialized AI models can be trained using specialized training sets to perform specific abilities (e.g. longer context, higher resolution images). Additionally, the specialized AI models can include different speeds, costs, or accuracy tradeoffs. Moreover, the specialized AI models can have different access to proprietary data. As such, there is a need to autonomously select the optimal AI models for an input query.

To do this, the following challenges can be tackled: How can agents publish their abilities in a way that helps other agents decide when to use them? How can an agent honestly show what it is confident about and when it may be hallucinating or following a bias? How can auditor agents accredit LLM abilities?

However, given the colossal number of developed AI models, simply running the input query for each candidate agent would be almost impossible. Additionally, for efficient and effective solution to an input query, selected AI models can be incentivized with computational resources or running costs. However, models should not be rewarded through usage for claiming abilities that they do not have.

Current systems introduce a cascade of LLMs to avoid calling expensive LLM’s on easy problems. These systems estimate a quality of the response of each LLM without using ground truthand decides whether to continue based on this estimate. However, these systems work only with a small number of LLMs that you can arrange in order in a chain. Additionally, these systems require explicit calls to the candidate LLM on the query before it decides whether the candidate is good or not.

The present embodiments resolve these challenges by estimating performance and accuracy of AI models based on audited examples most similar to the input query. After model score estimates are obtained, other considerations (latency, cost, etc.) may be used to select a model to run.

By doing so, the present embodiments improve the general-purpose skill features to better cover special instruction types and provide models and datasets for testing. Additionally, the present embodiments reduce computational complexity and storage cost by limiting the number of executions and explicit calls to the AI agents to determine the optimal AI agent to perform the input query.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

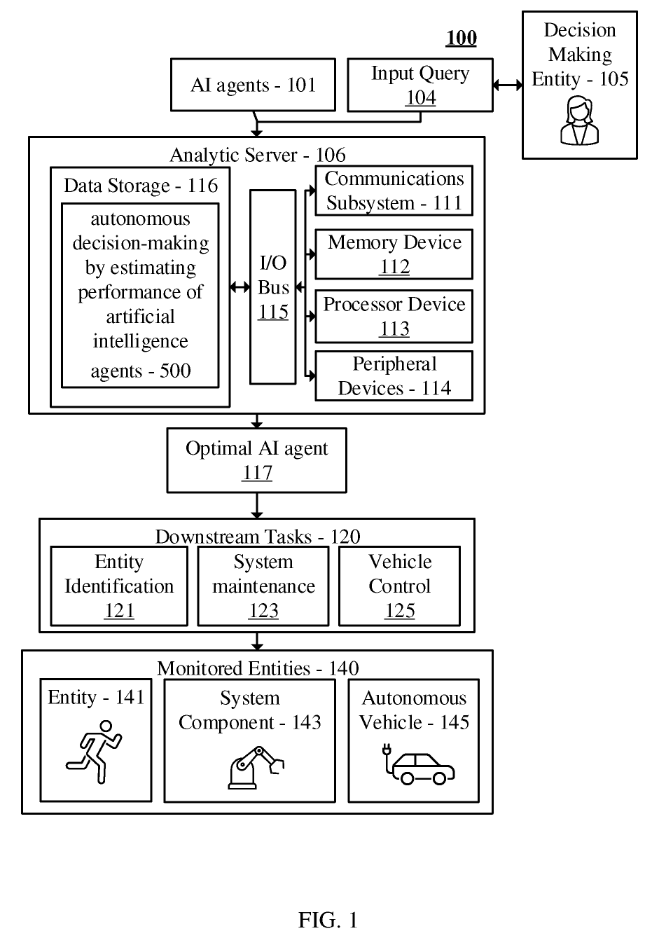

Referring now in detail to the figures in which like numerals represent the same or similar elements and initially to FIG. 1, a block diagram shows a system for automated decision making by estimating performance of artificial intelligence agents, in accordance with an embodiment of the present invention.

In an embodiment using a system 100, monitored entities 140 can include entity 141, system component 143, and autonomous vehicle 145. The monitored entities 140 can generate input data such as image/video, texts, audio, etc. The user queries 104 obtained from decision making entity 105 can be transmitted to an analytic server 106 that can implement automated decision making by estimating performance of artificial intelligence agents 500. The user queries 104 can include the multi-modality data such as image/videos, text, audio, etc. The analytic server 106 can obtain an optimal AI agent 117 that can be utilized to perform downstream tasks 120.

System 100 can be utilized to perform downstream tasks 120 based on the user query 104 from a decision-making entity 105. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, input image/video or text description (e.g., location images, scene images, entity images such as parts of the entity, etc.) related to the entity 141 can be processed by the analysis server 106 to answer user query 104. The user query 104 can be relevant to the entity 141 such as their attributes (e.g., position, direction of movement, color of clothing, etc.), relationship with other entities within a scene (e.g., proximity, behavior, etc.), relationship with the environment, etc. The optimal AI agent 117 can predict future attributes, and relationships of the entity 141.

Based on the predictions of the optimal AI agent 117, a corrective action can be generated by the optimal AI agent 117. The corrective action can include notifying the decision making entity 105 of the predictions about the entity 141 based on their image/video, generating resolutions to an issue caused by the entity (e.g., the entity 141 as a disabled vehicle in a traffic scene and the resolution is the deployment of a repair technician, etc.) of the image/video to help with the decision making process of the decision making entity 105, etc.

In system maintenance 123, image/video or text description (e.g., system logs, test cases, hardware status images, etc.) related to the system component 143 can be processed to answer user query 104. The user query 104 can be relevant on how to properly maintain the system component 143, or whether the system component is properly functioning based on the input image/video. A corrective action can be generated by the analytic server 106 which can include the answer to the user query 104 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, redirecting processing of component, etc.) the network system can be autonomously maintained.

In vehicle control 125, image/video (e.g., vehicle part status, traffic scene image, etc.) related to the autonomous vehicle 145 can be processed to answer user query 104. The user query 104 can be relevant on how to control the autonomous vehicle 145 given its environment based on the image/video or text description. A corrective action can be generated by the analytic server 106 which can include the answer to the user query 104 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled to avoid a predicted event based on a generated trajectory based on the query responses 119 generated by the analysis server 106 such as multi-vehicle collision, accidents, detected road hazards, etc.

### Other downstream tasks and practical applications are contemplated.

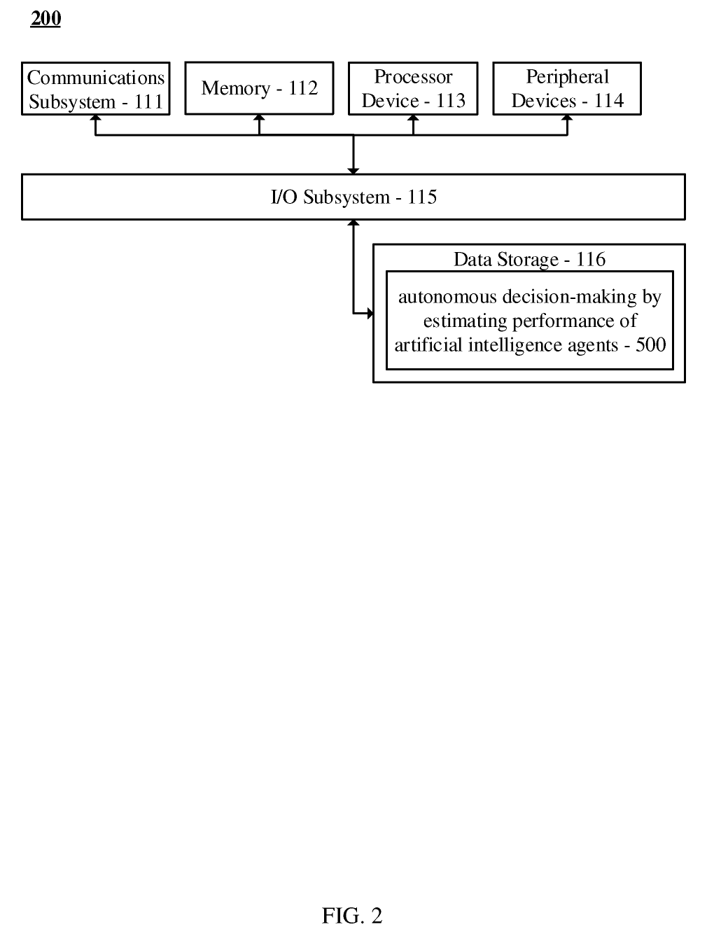

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for automated decision making by estimating performance of artificial intelligence agents, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for automated decision making by estimating performance of artificial intelligence agents 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

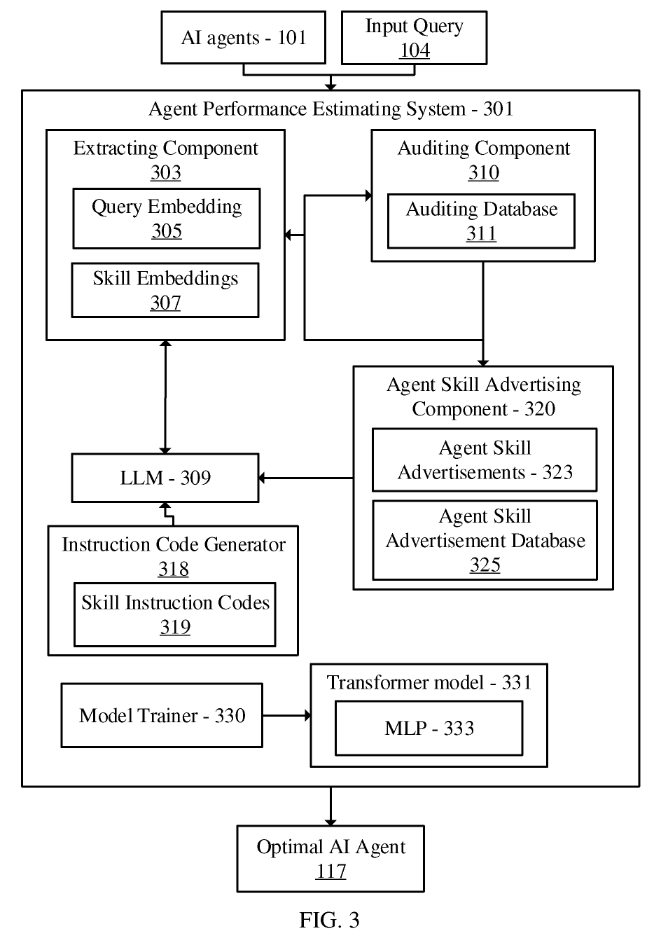

Referring now to FIG. 3, a block diagram shows components of a computer system for automated decision making by estimating performance of artificial intelligence agents, in accordance with an embodiment of the present invention.

In an embodiment, an agent performance estimating system (APES) 301 can select an optimal AI agent 117 from AI agents 101 based on an input query 104. The APES 301 can include an extracting component 303, an auditing component 310, instruction code generator 318, an agent skill advertising component 320, model trainer 330, and transformer model 331.

The extracting component 303 can extract query embedding 305 from an input query 104. The extracting component 303 can extract skill embeddings 307 from a response from LLM 309 regarding agent skills to be utilized based on the input query 104. The extracting component 303 can utilize transformer model 331 to extract the embeddings. The transformer model 331 can include a multi-layer perceptron (MLP) 333.

The auditing component 310 can utilize the query embedding 305 and the skill embeddings 307 to obtain similar queries to the input query and determine the performance of the AI agents 101 to the similar queries. The inputs/outputs of the auditing component 310 can be saved in the auditing database 311.

The agent skill advertising component 320 uses agent skills advertisements 323 that verify the skills to be used by AI-agents 101 to perform/answer input query 104. The input/outputs of the agent skill advertising component 320 can be saved in the agent skill advertisement database 325.

The instruction code generator 318 can generate skill instruction codes 319 that can be utilized by the LLM 309 to generate skill embeddings 307.

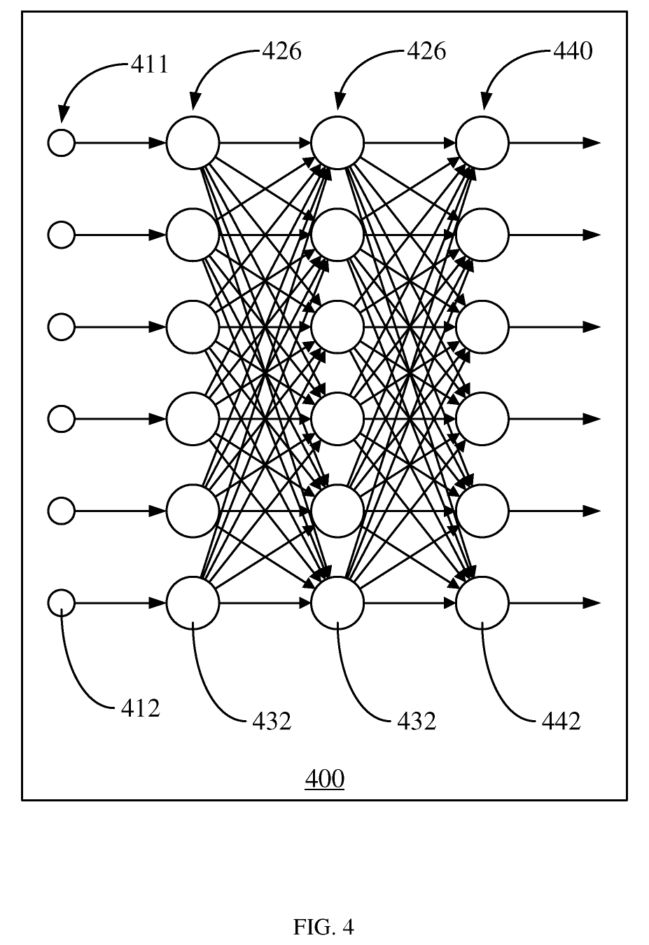

Referring now to FIG. 4, a block diagram shows a neural network for optimized multi-modality processing with artificial intelligence agents, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example’s input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 400, such as a multilayer perceptron, can have an input layer 411 of source neurons 412, one or more computation layer(s) 426 having one or more computation neurons 432, and an output layer 440, where there is a single output neuron 442 for each possible category into which the input example could be classified. An input layer 411 can have a number of source neurons 412 equal to the number of data values 412 in the input data 411. The computation neurons 432 in the computation layer(s) 426 can also be referred to as hidden layers, because they are between the source neurons 412 and output neuron(s) 442 and are not directly observed. Each neuron 432, 442 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, … w_{n-1,} wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons 432 in the one or more computation (hidden) layer(s) 426 perform a nonlinear transformation on the input data 412 that generates a feature space. The classes or categories may be more easily separated in the feature space than in the original data space.

In an embodiment, the present embodiments can train the MLP 333 or fine-tune the pretrained transformer model 331 using regression with the auditing database 311 to learn the relevance of tokens within query embedding 305 and skill embeddings 307 and an input query to more efficiently estimate the performance of the AI agents 101.

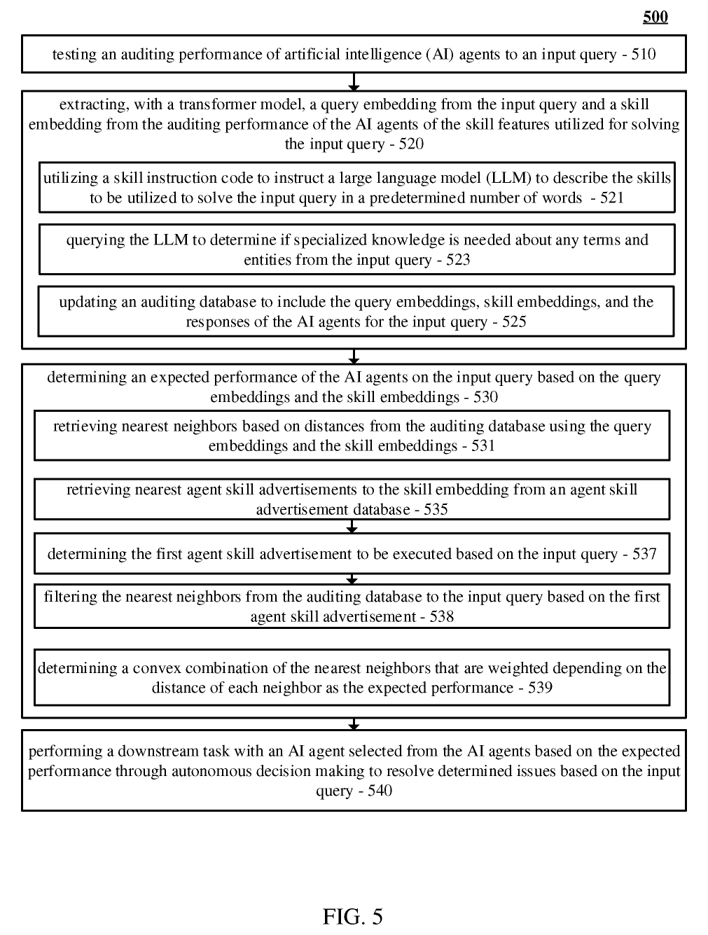

Referring now to FIG. 5, a block diagram shows a high-level overview of a method for autonomous decision-making by estimating performance of artificial intelligence agents, in accordance with an embodiment of the present invention.

In an embodiment, an auditing performance of artificial intelligence (AI) agents to an input query can be tested. A query embedding from the input query and a skill embedding can be extracted with a transformer model from the auditing performance of the AI agents of skill features utilized for solving the input query. An expected performance of the AI agents on the input query can be determined based on the query embedding and the skill embedding. A downstream task can be performed with an AI agent selected from the AI agents based on the expected performance through autonomous decision making to resolve determined issues based on the input query.

In block 510, an auditing performance of artificial intelligence (AI) agents to an input query can be tested. In an embodiment, the auditing performance of AI agents 101 to the input query 104 can be tested. The auditing performance can include the accuracy, speed, cost, and latency of the AI agents 101 for the input query 104. The response of the AI agents to the input query 104 can be provided to the decision-making entity 105.

In block 520, a query embedding from the input query and a skill embedding can be extracted with a transformer model from the auditing performance of the AI agents of skill features utilized for solving the input query. In an embodiment, the skill embedding 307 includes learned representations based on tokens from an assessment response to a query to the LLM 309 regarding the model skills to be utilized to perform and answer the input query 104. For example, the LLM 309 might be queried “What skills are necessary to answer this question?” and the response may be “algebra”, and the skill embedding 307 is a transformer model’s 331 embedding of the word “algebra.”

The similar queries can be obtained based on query embedding 305 and the skill embedding 307. The LLM 309 can be utilized to generate similar queries based on the query embeddings 305 and the skill embeddings 307.

In block 521, a skill instruction code can be utilized to instruct the LLM 309 to describe the skills to be utilized to solve the input query in a predetermined number of words (e.g., one, two, etc.). In an embodiment, the query embedding 305 includes learned representations based on tokens from the input query 104. The transformer model 331 can extract the query embedding 305 and skill embeddings 307. Continuing the example, a query could be “Solve x+2 = 5 for x”, the query embedding would be the transformer model’s 331 embedding of that phrase, and the skill embedding would be the transformer model’s 331 embedding of the word “algebra.”

In an embodiment, specialized knowledge can be filtered in the input query 104. In block 523, to filter specialized knowledge, the LLM 309 can be queried to determine if specialized knowledge is needed about any terms and entities from the input query. If so, a query term vector for the query embedding 305 can be obtained with only these terms. Each model with access to specialized data (pre-trained or in-context) has registered a normalized term frequency vector. The top ranked models by dot product of query term frequency-inverse document frequency (TFIDF) vector against model TFIDF vectors can be considered.

In block 525, an auditing database can be updated to include the query embeddings, skill embeddings, and the auditing performance of the AI agents for the input query. In an embodiment, the auditing database 311 can include responses of AI models 101 for a query, and their corresponding query embedding 305 and skill embeddings 307. The query can be included in the similar queries or as a part of the input query 104.

In block 530, an expected performance of the AI agents on the input query can be determined based on the query embedding and the skill embedding.

In block 531, to determine the expected performance of the AI agents 101 on the input query 104, nearest neighbors based on distances can be retrieved from the auditing database using the query embeddings 305 and the skill embeddings 307. In an embodiment, to determine the expected performance, a regression machine learning method such as K-nearest neighbors can be utilized. An agent skill advertisement 323 can be utilized which is triggered by the skills from the input query which is embedded in the skills embedding 307. In an embodiment, the skill instruction code 319 may not yield an adequate description of all skills needed. To resolve this issue, an agent skill advertisement 323 can be utilized to identify more particular skills for the input query 104.

The agent skill advertisement 323 is an instruction code to the LLM 309 to be answered with a Boolean format (e.g., “yes” or a “no”), together with a skill name that should trigger the agent skill advertisement. For example, an agent skill advertisement for ”Medical” skill can include “Does this question require interpretation of a chest X-ray?.” Example: Advertisement for “Mathematics” skill: “Is this question about geometry?”. The agent skill advertisements 323 with skill name embedding closest to the skill embedding 307 have their corresponding skill instruction codes 319 executed with respect to the input query 104.

The agent skill advertisement database 325 includes the agent skill advertisement 323 for past similar queries. The agent skill advertisement 323 can be written and provided by the provider of the AI agents 101. In another embodiment, the AI agents 101 can learn to provide the agent skill advertisement 323 based on past similar queries.

In block 535, the nearest agent skill advertisements to skill embedding can be retrieved from an agent skill advertisement database. In an embodiment, the top k agent skill advertisements are chosen based to proximity to the embedding of the one-word “skill” feature.

In block 537, the first agent skill advertisement to be executed based on the input query can be determined. In an embodiment, the nearest agent skill advertisement 323which is answered with an affirmative (e.g., ”yes”) on the query can be determined as the first agent skill advertisement 323. In the case of a tie, the more expensive agent skill advertisement 323 is run first. For example, if the input query 104 is related to a geometry question, the only neighbors considered are those that were also geometry questions. This gives a more fine-grained set of neighbors for estimating the accuracy of the AI agents 101.

In block 538, a first skill advertisement answered with an affirmative based on the input query can be used to filter the nearest neighbors. In an embodiment, examples with a query on which the agent skill advertisement 323 is answered affirmatively can be used as neighbors to estimate the expected performance.

In block 539, the expected performance can be determined as a convex combination of the nearest neighbors that are weighted depending on the distance of each neighbor.

In an embodiment, the score estimation of the expected performance can utilize the MLP 333 and the same features as without the advertisement. It allows the model to demonstrate strength in its specialization. An AI agent provider can submit an agent skill advertisement 323, however, if an AI agent doesn’t score well on the filtered audited neighbors, that AI agent may not achieve the highest score to execute the input query 104. This establishes trust in the ecosystem.

The expected performance can include other fixed factors known about each agent, such as the agent’s price, latency, speed, memory requirements, permitted context length, or acceptance and resolution of multi-modal input, in relation to the user’s requirements.

In block 540, a downstream task can be performed with an AI agent selected from the AI agents based on the expected performance through autonomous decision making to resolve determined issues based on the input query.

In an embodiment, the optimal AI agent 117 as the selected AI agent based on the expected performance can perform downstream tasks and automated decision making to resolve determined issues based on the input query.

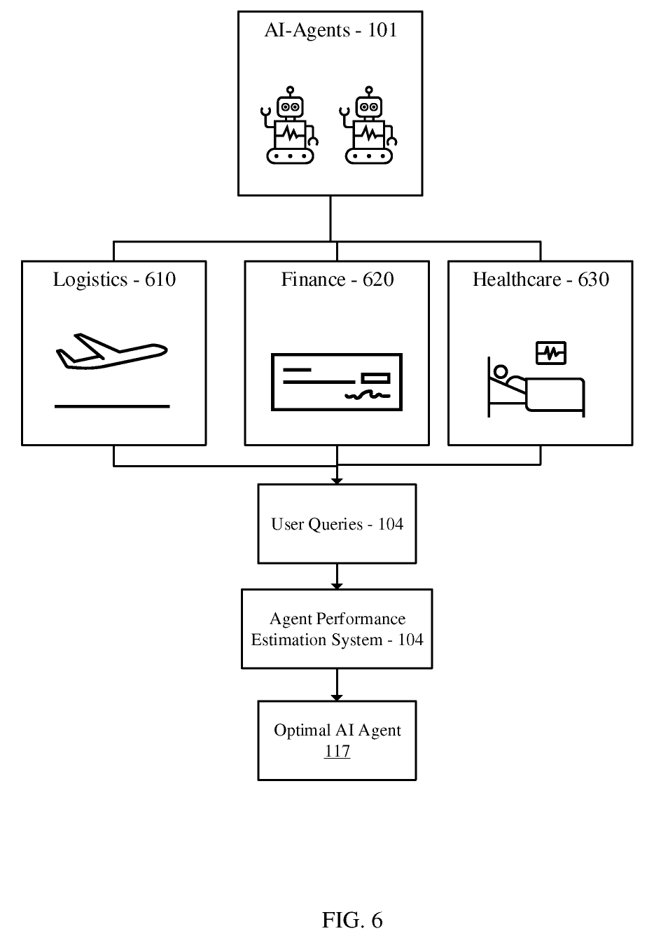

Referring now to FIG. 6, a block diagram shows practical applications of autonomous decision-making by estimating performance of artificial intelligence agents, in accordance with an embodiment of the present invention.

In the logistics sector 610, planning optimal international shipping routes is challenging due to complex, fluctuating factors like real-time traffic, weather, and customs regulations. In an embodiment, AI agents 101 for planning optimal international shipping routes can be utilized by a decision-making entity 105. However, due to the number of available AI agents 101 that plans optimal international shipping routes a decision-making entity 105 is oblivious to the optimal AI agent available. The decision-making entity 105 can request the following to an AI agent: "Plan the most cost-effective and secure route to transport precision equipment from Tokyo to Paris within 72 hours." The present embodiments can extract skills like "precision equipment" and "international transport" from the query and instantly selects the optimal AI agent 117 based on historical audit data. This enables rapid creation of reliable transport plans that account for real-time variables, reducing delays and costs. In another embodiment, real-time traffic analysis, global weather forecasts, and international customs and regulations can be tackled with specialized AI agents.

In the financial field 620, a comprehensive and objective loan assessment is required, incorporating not only traditional financial data but also non-financial factors like technology value, industry prospects, and ESG. In another embodiment, AI agents 101 for assessing loans can be utilized. However, due to the number of available AI agents 101 that assesses loans, the decision-making entity 105 is oblivious to the optimal AI agent available. The decision-making entity 105 can request the following to an AI agent: "Assess a $5 million loan application from a semiconductor startup for capital expenditure." The present embodiments can extract skills like "semiconductor" and "startup" from the query and provides multifaceted analysis from various specialized AIs and select the optimal AI agent 117. The decision-making entity 105 (e.g., underwriters) can then make higher-quality decisions based on objective data, identifying risks and opportunities that might otherwise be missed, significantly improving the quality and speed of underwriting. In another embodiment, financial statement analysis, technology and patent valuation, and industry trend/market growth prediction can be tackled with specialized AI agents.

In the healthcare field 630, it is difficult to transform the vast amount of biometric data (heart rate, sleep, etc.) collected 24/7 from devices like smartwatches into medically meaningful insights. Early intervention based on specialized analysis, rather than generic alerts, is needed. In another embodiment, AI agents 101 for generating medical insights from biometric data can be utilized. However, the number of available AI agents 101 adds an additional burden to the decision-making entity 105 (e.g., healthcare provider) to select the optimal AI agent available. The decision-making entity 105 can request the following to an AI agent: “A user's continuous biometric data for the past week, including heart rate (HR), heart rate variability (HRV), and blood oxygen saturation (SpO2).” The present embodiments can extract abnormal patterns like "irregular nighttime heartbeats" from patient healthcare data as a skill from the data and instantly selects the optimal AI agent 117 based on historical audit data. For example, it invokes the "AFib Screening AI" for detailed analysis. This promotes early detection before symptoms appear, contributing to the prevention of serious illness. In another embodiment, atrial fibrillation screening, sleep apnea syndrome detection, autonomic nervous system and stress level assessment can be tackled with specialized AI agents.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
testing an auditing performance of artificial intelligence (AI) agents to an input query;
extracting, with a transformer model, a query embedding from the input query and a skill embedding from the auditing performance of the AI agents of skill features utilized for solving the input query;
determining an expected performance of the AI agents on the input query based on the query embedding and the skill embedding; and
performing a downstream task with an AI agent selected from the AI agents based on the expected performance through autonomous decision making to resolve determined issues based on the input query.

2. The method of claim 1, wherein extracting the skill embedding further comprises utilizing a skill instruction code to instruct a large language model (LLM) to describe the skills to be utilized to solve the input query in a predetermined number of words.

3. The method of claim 1, wherein extracting the query embedding and the skill embedding further comprises updating an auditing database to include the query embeddings, skill embeddings, and responses of the AI agents for the input query.

4. The method of claim 3, wherein determining the expected performance further comprises retrieving nearest neighbors based on distances from the auditing database using the query embeddings and the skill embeddings.

5. The method of claim 2, wherein determining the expected performance further comprises utilizing an agent skill advertisement to extract the skills from the input query.

6. The method of claim 5, wherein determining the expected performance further comprises retrieving nearest agent skill advertisements to the skill embedding from an agent skill advertisement database.

7. The method of claim 6, wherein determining the expected performance further comprises determining a first agent skill advertisement to be executed based on the input query.

8. The method of claim 7, wherein determining the expected performance further comprises filtering the nearest neighbors from the auditing database to the input query based on the first agent skill advertisement.

9. The method of claim 4, wherein determining the expected performance further comprises determining a convex combination of the nearest neighbors that are weighted depending on the distance of each neighbor as the expected performance.

10. The method of claim 1, wherein the downstream task further comprises extracting abnormal patterns from a patient healthcare data to generate medical insights to assist a decision-making of a healthcare provider.

11. A system, comprising:
a memory device;
one or more processor devices operatively coupled with the memory device to perform operations including:
testing an auditing performance of artificial intelligence (AI) agents to an input query;
extracting, with a transformer model, a query embedding from the input query and a skill embedding from the auditing performance of the AI agents of skill features utilized for solving the input query;
determining an expected performance of the AI agents on the input query based on the query embedding and the skill embedding; and
performing a downstream task with an AI agent selected from the AI agents based on the expected performance through autonomous decision making to resolve determined issues based on the input query.

12. The system of claim 11, wherein extracting the skill embedding further comprises utilizing a skill instruction code to instruct a large language model (LLM) to describe the skills to be utilized to solve the input query in a predetermined number of words.

13. The system of claim 11, wherein extracting the query embedding and the skill embedding further comprises updating an auditing database to include the query embeddings, skill embeddings, and responses of the AI agents for the input query.

14. The system of claim 13, wherein determining the expected performance further comprises retrieving nearest neighbors based on distances from the auditing database using the query embeddings and the skill embeddings.

15. The system of claim 12, wherein determining the expected performance further comprises utilizing an agent skill advertisement to extract the skills from the input query.

16. The system of claim 15, wherein determining the expected performance further comprises retrieving nearest agent skill advertisements to the skill embedding from an agent skill advertisement database.

17. The system of claim 16, wherein determining the expected performance further comprises determining a first agent skill advertisement to be executed based on the input query.

18. The system of claim 14, wherein determining the expected performance further comprises determining a convex combination of the nearest neighbors that are weighted depending on the distance of each neighbor as the expected performance.

19. The system of claim 11, wherein the downstream task further comprises extracting abnormal patterns from a patient healthcare data to generate medical insights to assist a decision-making of a healthcare provider.

20. A non-transitory computer program product comprising a computer-readable storage medium including a program code, wherein the program code when executed on a computer causes the computer to perform operations including:
testing an auditing performance of artificial intelligence (AI) agents to an input query;
extracting, with a transformer model, a query embedding from the input query and a skill embedding from the auditing performance of the AI agents of skill features utilized for solving the input query;
determining an expected performance of the AI agents on the input query based on the query embedding and the skill embedding; and
performing a downstream task with an AI agent selected from the AI agents based on the expected performance through autonomous decision making to resolve determined issues based on the input query.
